(19) United States
(12) Patent Application Publication
(10) Pub. No.: US 2011/0102237 A1
(43) Pub. Date: May 5, 2011

(54) Fusion Algorithm for Vidar Traffic Surveillance System

(76) Inventors: Lang Hong, Beavercreek, OH (US); Arunesh Roy, Dayton, OH (US); Nicholas Christopher Gale, Wilmington, OH (US)

(21) Appl. No.: 12/333,735

(22) Filed: Dec. 12, 2008

(51) Int. Cl. G01S 13/86; G01S 13/58; G01S 13/42

(52) U.S. Cl. 342/55

(57) ABSTRACT

This invention is related to a fusion algorithm for a video-Doppler-radar (Vidar) traffic surveillance system comprising of (1) a robust matching algorithm which iteratively matches the information from a video camera and multiple Doppler radars corresponding to a same moving vehicle, and (2) a stochastic algorithm which fuses the matched information from the video camera and Doppler radars to derive the vehicle velocity and range information.

### TECHNICAL FIELD

This invention relates to a fusion algorithm for a Vidar traffic surveillance system.

### BACKGROUND OF THE INVENTION

A traditional radar based traffic surveillance system uses a Doppler radar for vehicle speed monitoring which measures a vehicle speed at line-of-sight (LOS). In FIG. 1, the speed of an approaching (or a leaving) vehicle is calculated in terms of Doppler frequency f_{D} by

$${v}_{t} = \frac{{f}_{D}}{K cos ( {φ}_{t} )} \qquad ( 1 )$$

where K is a Doppler frequency conversion constant and φₜ is called the Doppler cone angle or simply the Doppler angle. Although a Doppler radar based system has an advantage of a long detection range, there are several difficulties associated with the traditional radar based system, including (1) the Doppler radar beam angle is too large to precisely locate vehicles within the radar beam; (2) the angle between the vehicle moving direction and the LOS, is unknown and therefore, needs to be small enough for a reasonable speed estimation accuracy; (3) since all velocity vectors on the equal-Doppler cone in FIG. 1 will generate a same speed, the Doppler radar cannot differentiate the vehicles with a same speed but different directions defined by the same equal-Doppler cone. Therefore, no precise target location information can be derived in a traditional Doppler radar based traffic surveillance system.

### Video Camera Based Traffic Surveillance Systems

A video camera based traffic surveillance system uses a video camera to capture a traffic scene and relies on computer vision techniques to indirectly calculate vehicle speeds. Precise vehicle locations can be identified. However, since no direct speed measurements are available and the camera has a finite number of pixels, the video camera based traffic surveillance system can be used only in a short distance application.

### Video-Doppler-Radar (Vidar) Traffic Surveillance Systems

A video-Doppler-radar (Vidar) traffic surveillance system combines both the Doppler radar based system and the video based system into a unique system to preserve the advantages of both systems and overcome the shortcomings of both systems. A patent application on Vidar traffic surveillance system has been filed by the first author, Patent Application No. 12266227.

A Vidar traffic surveillance system may include a first movable Doppler radar to generate a first radar beam along the direction of a first motion ray, a second movable Doppler radar to generate a second radar beam along the direction of a second motion ray, a third fixed Doppler radar to generate a third radar beam along a direction ray, a video camera to serve as an information fusion platform by intersecting the first and second radar motion rays with the camera virtual image plane, a data processing device to process Doppler radar and video information, a tracking device to continuously point the surveillance system to the moving vehicle, and a recording device to continuously record the complete information of the moving vehicle.

Robustly matching information from a video camera and multiple Doppler radars is a prerequisite for information fusion in a Vidar traffic surveillance system. However, because of the different modalities of video and Doppler radar sensors, matching information from a video camera and Doppler radars is very difficult. Due to the special video-radar geometry introduced in Vidar, correctly matching between a video sequence and Doppler signals is possible. This invention describes a robust algorithm to match video signals and Doppler radar signals, and an algorithm to fuse the matched video and Doppler radar signals.

### SUMMARY

A fusion algorithm for a Vidar traffic surveillance system may include the following steps: (1) deriving Doppler angles from a video sequence; (2) generating estimated Doppler signals from estimated Doppler angles; (3) matching estimated Doppler signals to the measured Doppler signals of two moving Doppler radars; (4) finding the best match between the estimated and measured Doppler signals; (5) forming a three-scan, range-Doppler geometry from the stationary Doppler radar and estimated Doppler angles; (6) matching video signals to stationary Doppler radar signals; (7) fusing the matched video and Doppler radar signals to generate moving vehicle velocity and range information.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates the fundamental of a Doppler radar for speed measuring;

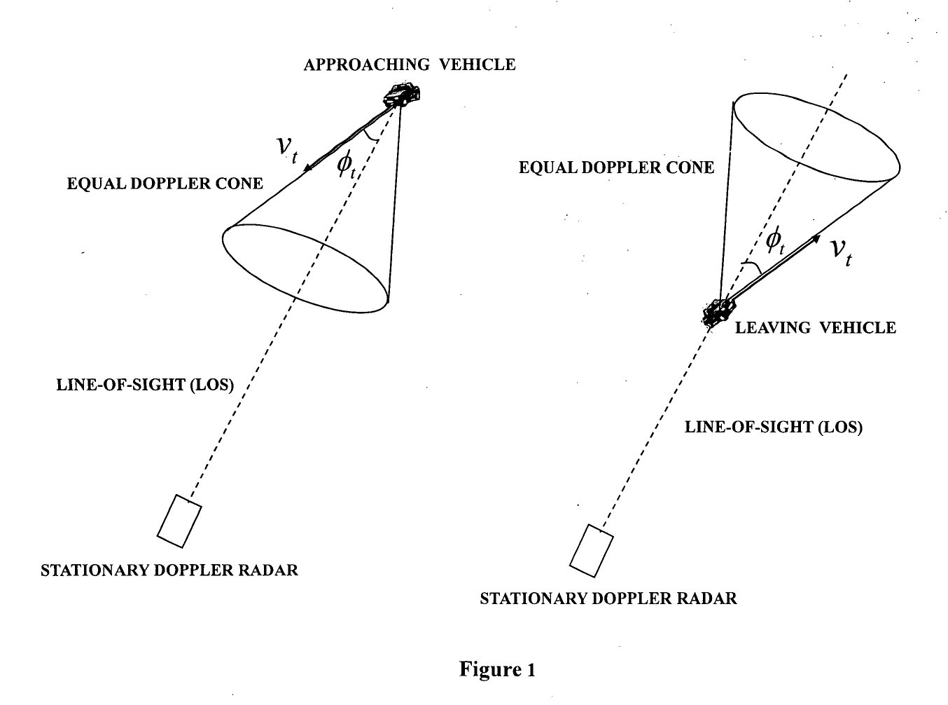

FIG. 2 illustrates the functional flow chart of the fusion algorithm;

FIG. 3 illustrates the layout of the Vidar sensor suite;

FIG. 4 illustrates the sensing geometry of the Vidar traffic surveillance system; and

FIG. 5 illustrates a three-scan geometry for fusing video and Doppler radar signals.

### DETAILED DESCRIPTION

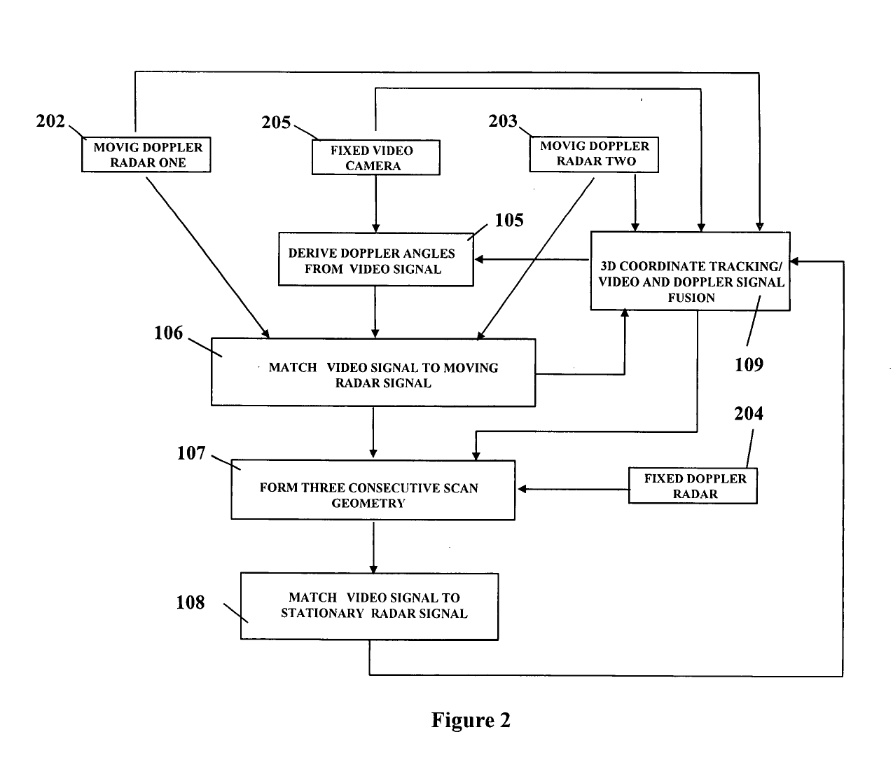

The functional flow chart of the algorithm is shown in FIG. 2. In the following, we will provide detailed description of the invention.

### BRIEF DESCRIPTION OF VIDAR SENSOR SUITE

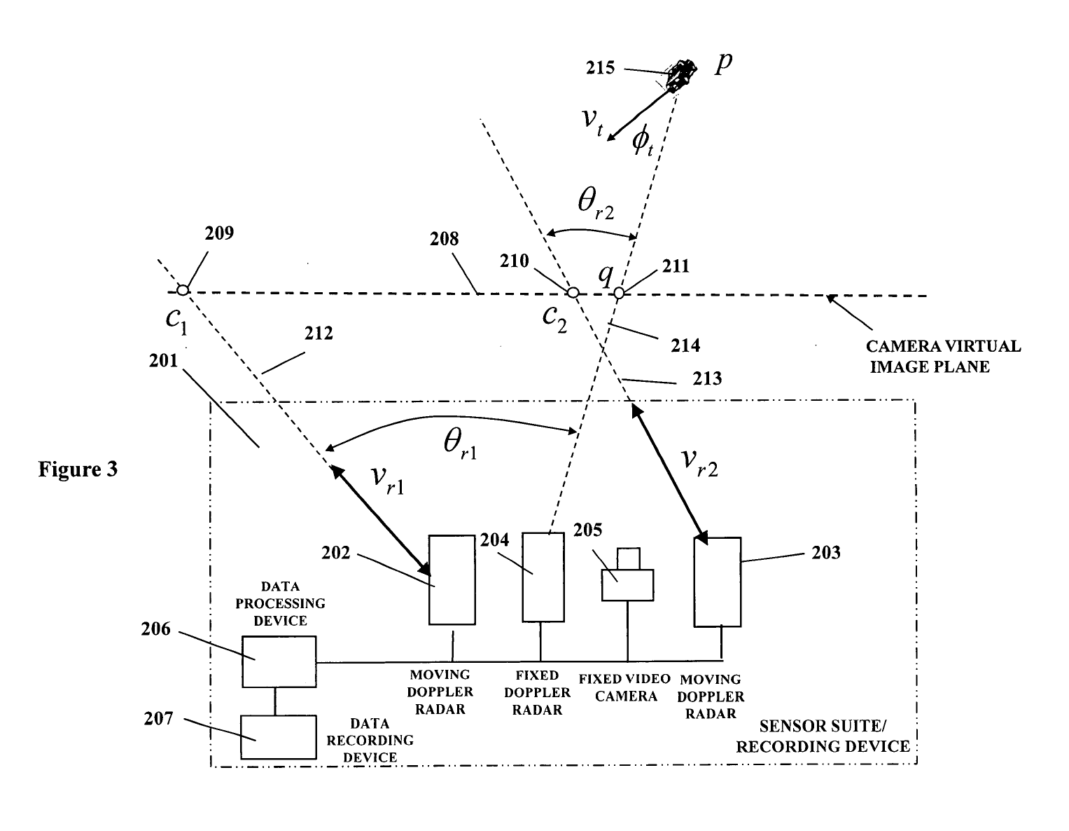

FIG. 3 shows the layout of the Vidar sensor suite 201 where 202—a first moving Doppler radar, 203—a second moving Doppler radar, 204—a fixed or stationary Doppler radar, 205—a fixed or stationary video camera, 206—a data processing device, such as a computer, laptop, personal computer, PDA or other such device, and 207—a data recording device, such as a hard drive, a flash drive or other such device. FIG. 3 also indicates the sensing geometry where 208—the camera virtual image plane of the video camera 205, 212—a first moving Doppler radar motion ray, 213—a second moving Doppler radar motion ray, 214—a radar direction ray connecting the Vidar device apparatus 201 to a moving vehicle 215, 209—the intersection of the first Doppler radar motion ray 212 with the virtual image plane 208, 210—the intersection of the second Doppler radar motion ray 213 with the virtual image plane 208, 211—the intersection of the ray connecting the Vidar apparatus 201 and the moving vehicle 215 with the virtual image plane 208, and 215 a moving vehicle. The first and second Doppler radars 202, 203 in the Vidar apparatus 201 may be moved in such a way that the vehicle 215 is located in one side of both moving radar motion rays 212 and 213 with sufficiently large angles θ_{τ1} and θ_{τ2}. The first and second Doppler radars 202, 203 in the Vidar apparatus 201 may be extended or retracted or moved side to side as illustrated in FIG. 3 by a motor (not shown) which may be a DC or stepper motor or other movement device and may be moved on sliding tracks (not shown). An optical encoder (not shown) may be mounted on the shaft of the motor, so the sliding speeds of the Doppler radars (υ_{τ1} and υ_{τ2} in FIG. 3) may be predetermined. The sliding track orientation angles (θ_{τ1} and θ_{τ2} in FIG. 3) may also be predetermined. Using a calibration method, the intersections 209 and 210 of the first and second motion rays 212, 213 with the virtual image planes 208 may be predetermined as well.

Derive Doppler Angles from a Video Sequence

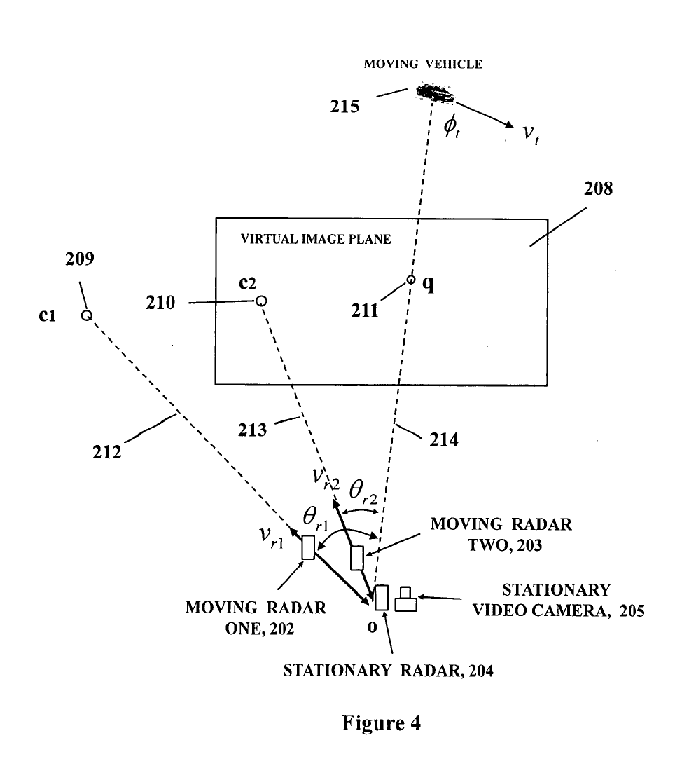

The objective of this step (step 105 in FIG. 2) is to derive Doppler angle pairs, {θ_{τ}_{₁ₖ}, θ_{τ}_{₂ₖ}} as indicated in FIG. 4 where the subscript k is suppressed, from an image sequence. Assume the vehicle location on the image is qₖ=[uₖ, υₖ], as shown in FIG. 4. The vector from O to qₖ may be defined as Oqₖ=[uₖ, υₖ, f] where f is the camera focal length, and the vectors from O to C₁ and C₂ may be given by: OC₁=[u_{c1}, υ_{c1}, f] and OC₂=[u_{c2}, υ_{c2}, f]. The Doppler angles may be estimated in step 105 by

$$\begin{matrix}{\hat{θ}}_{{r}_{1 k}} = {cos}^{- 1} \frac{{\underline{Oq}}_{k} \cdot {\underline{OC}}_{1}}{‖ {\underline{Oq}}_{k} ‖ ‖ {\underline{OC}}_{1} ‖} & ( 2 ) \\ = \frac{{u}_{k} {u}_{c 1} + {v}_{k} {v}_{c 1} + {f}^{2}}{\sqrt{{u}_{k}^{2} + {v}_{k}^{2} + {f}^{2}} \sqrt{{u}_{c 1}^{2} + {v}_{c 1}^{2} + {f}^{2}}} \\ and & ( 3 ) \\ {\hat{θ}}_{{r}_{2 k}} = {cos}^{- 1} \frac{{\underline{Oq}}_{k} \cdot {\underline{OC}}_{2}}{‖ {\underline{Oq}}_{k} ‖ ‖ {\underline{OC}}_{2} ‖} & ( 4 ) \\ = \frac{{u}_{k} {u}_{c 2} + {v}_{k} {v}_{c 2} + {f}^{2}}{\sqrt{{u}_{k}^{2} + {v}_{k}^{2} + {f}^{2}} \sqrt{{u}_{c 2}^{2} + {v}_{c 2}^{2} + {f}^{2}}} . & ( 5 )\end{matrix}$$

### Match Video Signals to Moving Radar Signals

Referring to FIG. 4, the Doppler angles may be related to the Doppler signals of the moving Doppler radars. For the first moving Doppler radar, the following holds

f_{D}_{ₖ}¹=K₁υ_{τ}_{₁ₖ} cos(θ_{τ}_{₁ₖ})+K₁υₜ_{ₖ} cos(φₖ) (6)

where υₜ_{ₖ} cos(φₖ) may be provided by the stationary Doppler radar via

f_{D}_{ₖ}³=K₃υₜ_{ₖ} cos(φₖ). (7)

Since the motion of the first moving Doppler radar is known as

υ_{τ}_{₁ₖ}=a₁ cos(ωtₖ+φ₁), (8)

we have

$$\begin{matrix}{f}_{{D}_{k}}^{1} = {K}_{1} {a}_{1} cos ( {θ}_{{r}_{1 k}} ) cos ( ω {t}_{k} + {ψ}_{1} ) + \frac{{K}_{1}}{{K}_{3}} {f}_{{D}_{k}}^{3} & ( 9 ) \\ = {A}_{1 k} cos ( ω {t}_{k} + {ψ}_{1} ) + {B}_{1 k} {f}_{{D}_{k}}^{3} \\ where & ( 10 ) \\ {A}_{1 k} = {K}_{1} {a}_{1} cos ( {θ}_{{r}_{1 k}} ) and {B}_{1 k} = \frac{{K}_{1}}{{K}_{3}} . & ( 11 )\end{matrix}$$

A similar equation may be derived for the second moving Doppler radar

$$\begin{matrix}{f}_{{D}_{k}}^{2} = {A}_{2 k} cos ( ω {t}_{k} + {ψ}_{2} ) + {B}_{2} {f}_{{D}_{k}}^{3} \\ where & ( 12 ) \\ {A}_{2 k} = {K}_{2} {a}_{2} cos ( {θ}_{{r}_{2 k}} ) and {B}_{2 k} = \frac{{K}_{2}}{{K}_{3}} & ( 13 )\end{matrix}$$

and a₁, a₂, K₁, K₂, K₃, φ₁, and φ₂ are all known from calibration. Given Doppler angle estimates, \hat{θ}_{τ}_{₁ₖ} and \hat{θ}_{τ}_{₁ₖ}, we have

Â₁ₖ=K₁a₁ cos(\hat{θ}_{τ}_{₁ₖ}) and Â₂ₖ=K₂a₂ cos(\hat{θ}_{τ}_{₂ₖ}). (14)

Within a predefined time window, cosine signals (Doppler signals) may be generated as

Â₁ₖ cos(ωt+φ₁) and Â₂ₖ cos(ωt+φ₂),tₖ−L≦t≦tₖ (15)

where L is the window length. It is straightforward to match estimated cosine signals to the measured Doppler signals in a single vehicle case using a least square method which is performed in step 106 of FIG. 2. For a multiple vehicles case, a multiple hypothesis test may be needed.

From the video camera, multiple pairs of Doppler angles are estimated:

$$\{ {\hat{θ}}_{{r}_{{1}_{k}}}^{i} , {\hat{θ}}_{{r}_{{2}_{k}}}^{i} \} , i = 1 , … , N$$

where N is the number of vehicles, which in turn generate multiple cosine signals as

Â₁ₖⁱ cos(ωt+φ₁) and Â₂ₖⁱ cos(ωt+φ₂),i=1, . . . , N.

Using multiple hypothesis testing, the moving radar Doppler data set {D₁ⁱ, D₂ⁱ} corresponding to

$$\{ {\hat{θ}}_{{r}_{{1}_{k}}}^{i} , {\hat{θ}}_{{r}_{{2}_{k}}}^{i} \}$$

may be identified (also in step 106 of FIG. 2), from which a set of new estimates may be derived:

$${{A}^{\hat{\_}}}_{1 k}^{i} cos ( ω t + {ϕ}_{1} ) + {{f}^{\hat{\_}}}_{{1}_{{D}_{k}}}^{3 i} and {{A}^{\hat{\_}}}_{2 k}^{i} cos ( ω t + {ψ}_{2} ) + {{f}^{\hat{\_}}}_{{2}_{{D}_{k}}}^{3 i} , \\ i = 1 , … , N .$$

### Combing

$${{f}^{\hat{\_}}}_{{1}_{{D}_{k}}}^{3 i} , {{f}^{\hat{\_}}}_{{2}_{{D}_{k}}}^{3 i} and {{f}^{\hat{\_}}}_{{D}_{k}}^{3 i}$$

from three Doppler radars, a more accurate Doppler frequency of the ith vehicle may be determined.

### Match Video Signals to Stationary Radar Signals

When two vehicles are close to each other, Doppler angles alone cannot set them apart. The stationary Doppler radar signals should provide additional information about their speeds. In general, it is relatively more accurate for a camera to measure an angle than derive a velocity. On the other hand, it is relatively more accurate for a Doppler radar to measure a velocity than derive an angle. The contribution of this invention is to robustly tie together the angle information from a video camera and the Doppler (velocity) information from a Doppler radar. In this invention, we will match angle rates from video signals to stationary Doppler radar signals via a unique three-scan geometry.

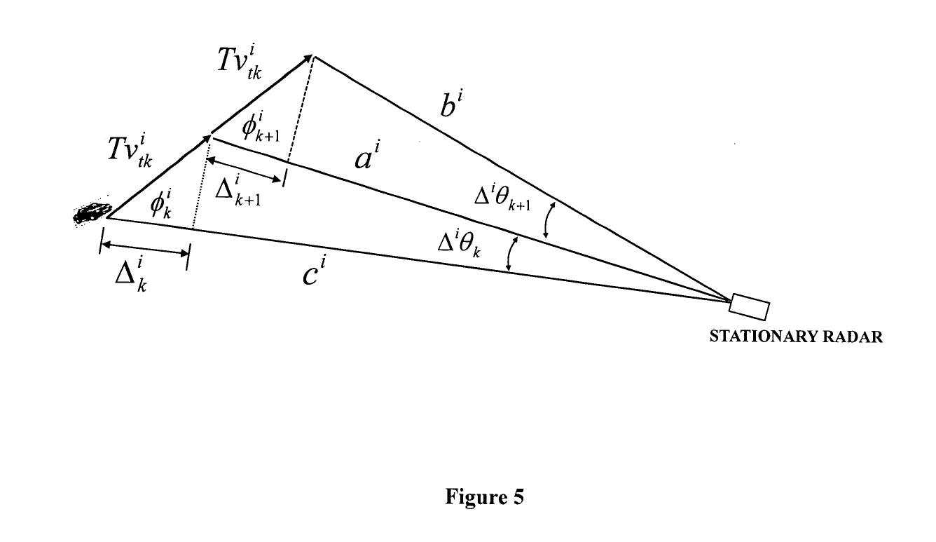

A three-scan geometry is shown in FIG. 5, where

$${Δθ}_{k}^{i} = {cos}^{- 1} \frac{{\underline{Oq}}_{k}^{i} \cdot {\underline{Oq}}_{k + 1}^{i}}{‖ {\underline{Oq}}_{k}^{i} ‖ ‖ {\underline{Oq}}_{k + 1}^{i} ‖} \\ and {Δθ}_{k + 1}^{i} = {cos}^{- 1} \frac{{\underline{Oq}}_{k + 1}^{i} \cdot {\underline{Oq}}_{k + 2}^{i}}{‖ {\underline{Oq}}_{k + 1}^{i} ‖ ‖ {\underline{Oq}}_{k + 2}^{i} ‖} \qquad ( 16 )$$

where Oqₖⁱ=[uₖⁱ, τₖⁱ, f] and Oqₖ₊₁ⁱ=[uₖ₊₁ⁱ, υₖ₊₁ⁱ, f] are the locations of the ith vehicle on the image plane. Assume a constant velocity model, i.e., υₜ_{ₖ}ⁱ=υₜ_{ₖ₊₁}ⁱ=|\dot{X}ₖⁱ|. Also assume that Doppler frequencies f³^{ⁱ}_{D}_{ₖ} and f³^{ⁱ}_{D}_{ₖ₊₁} are provided by the stationary Doppler radar. We then have

$${Δ}_{k}^{i} = T \frac{{f}_{{D}_{k}}^{{3}^{i}}}{{K}_{3}} and {Δ}_{k + 1}^{i} = T \frac{{f}_{{D}_{k + 1}}^{{3}^{i}}}{{K}_{3}} . \qquad ( 17 )$$

Using the cosine law, we have the constrained equation for the three-scan geometry (step 107 in FIG. 2) as

(a¹+Δₖⁱ)²+(aⁱ)²−2(aⁱ+Δₖ^{j})aⁱ cos(Δθₖⁱ)=(aⁱ−Δₖ₊₁ⁱ)²+(aⁱ)²−2(aⁱ−Δₖ₊₁ⁱ)aⁱ cos(Δθₖ₊₁ⁱ). (18)

Solving the following equation for

(aⁱ)²[2 cos(Δθₖ₊₁ⁱ)−2 cos(Δθₖⁱ)]+aⁱ[2Δₖⁱ+2Δₖ₊₁ⁱ−2Δₖⁱ cos(Δθₖⁱ)−2Δₖ₊₁ⁱ cos(Δθₖ₊₁ⁱ)]+(Δₖⁱ)²−(Δₖ₊₁ⁱ)²=0 (19)

we may find the range from the Vidar device to the vehicle which is performed in step 108 of FIG. 2. Similarly,

$${b}^{i} = {a}^{i} - T \frac{{f}_{{D}_{k + 1}}^{{3}^{i}}}{{K}_{3}} and {c}^{i} = {a}^{i} + T \frac{{f}_{{D}_{k}}^{{3}^{i}}}{{K}_{3}} . \qquad ( 20 )$$

The criterion for matching video signals to stationary Doppler radar signals becomes validating the following equation. Given an arbitrary Doppler signal pair from the stationary Doppler radar, say f³^{^{j}}_{D}_{ₖ} and f³^{^{j}}_{D}_{ₖ₊₁}, if it matches the video signals, the following equation should be satisfied

(aⁱ)²[2 cos(Δθₖ₊₁ⁱ)−2 cos(Δθₖⁱ)]+aⁱ[2Δₖ^{j}+2Δₖ₊₁^{j}−2Δₖ^{j} cos(Δθₖⁱ)−2Δₖ₊₁^{j} cos(Δθₖ₊₁ⁱ)]Δ(Δₖ^{j})²−(Δₖ₊₁^{j})²=0. (21)

### Fusion of Video and Doppler Signals

Once the matched video and Doppler radar signals are found, they are fed into a stochastic model for fusion, which is performed in step 109 of FIG. 2.

Assume the kinematics of the ith vehicle satisfy a stochastic constant velocity (CV) model

$${[ \begin{matrix}\underline{X} \\ \underline{\dot{X}}\end{matrix} ]}_{k + 1}^{i} = {[ \begin{matrix}I & IT \\ 0 & I\end{matrix} ] [ \begin{matrix}\underline{X} \\ \underline{\dot{X}}\end{matrix} ]}_{k}^{i} + [ \begin{matrix}\frac{1}{2} {IT}^{2} \\ I\end{matrix} ] {\underline{ρ}}_{k}^{i} , {\underline{ρ}}_{k}^{i} \sim N ( \underline{0} , {Q}_{k}^{i} ) \qquad ( 22 )$$

where Xₖⁱ=[xⁱ, y¹, zⁱ]ₖ is the ith vehicle's 3D coordinate. The positional measurement equation may be

$$\begin{matrix}0 = ( \frac{{Δ}^{i} {f}_{{D}_{k}}^{13}}{{Δ}^{i} {f}_{{D}_{k}}^{23}} {v}_{{r}_{2 xk}} - {v}_{{r}_{1 xk}} ) {x}_{k}^{i} + ( \frac{{Δ}^{i} {f}_{{D}_{k}}^{13}}{{Δ}^{i} {f}_{{D}_{k}}^{23}} {v}_{{r}_{2 yk}} - {v}_{{r}_{1 yk}} ) {y}_{k}^{i} + ( \frac{{Δ}^{i} {f}_{{D}_{k}}^{13}}{{Δ}^{i} {f}_{{D}_{k}}^{23}} {v}_{{r}_{2 zk}} - {v}_{{r}_{1 zk}} ) {z}_{k}^{i} & ( 23 ) \\ = [ \begin{matrix}\frac{{Δ}^{i} {f}_{{D}_{k}}^{13}}{{Δ}^{i} {f}_{{D}_{k}}^{23}} {v}_{{r}_{2 xk}} - {v}_{{r}_{1 xk}} , \\ \frac{{Δ}^{i} {f}_{{D}_{k}}^{13}}{{Δ}^{i} {f}_{{D}_{k}}^{23}} {v}_{{r}_{2 xk}} - {v}_{{r}_{1 xk}} , \frac{{Δ}^{i} {f}_{{D}_{k}}^{13}}{{Δ}^{i} {f}_{{D}_{k}}^{23}} {v}_{{r}_{2 xk}} - {v}_{{r}_{1 xk}}\end{matrix} ] {\underline{X}}_{k}^{i} + {\underline{γ}}_{xk}^{i} & ( 24 ) \\ = {( {\underline{v}}_{{r}_{{12}_{k}}}^{i} )}^{T} {\underline{X}}_{k}^{i} + {\underline{γ}}_{{x}_{k}}^{i} {\underline{γ}}_{{x}_{k}}^{i} \sim N ( \underline{0} , {R}_{{x}_{k}}^{i} ) . & ( 25 )\end{matrix}$$

The velocity measurement equation may be established as

$$\begin{matrix}{f}_{{D}_{k}}^{{3}^{i}} = {\overline{u}}_{k} {\dot{x}}_{k}^{i} + {\overline{v}}_{k} {\dot{y}}_{k}^{i} + \overline{f} {\dot{z}}_{k}^{i} + {\underline{γ}}_{{\dot{x}}_{k}}^{i} & ( 26 ) \\ = [ {\overline{u}}_{k} , {\overline{v}}_{k} , \overline{f} ] {\underline{\dot{X}}}_{k}^{i} + {\underline{γ}}_{{\dot{x}}_{k}}^{i} & ( 27 ) \\ = {\overline{\underline{oq}}}_{k}^{T} {\dot{\underline{X}}}_{k}^{i} + {\underline{γ}}_{{x}_{k}}^{i} \\ where & ( 28 ) \\ {\overline{u}}_{k} = {K}_{3} \frac{- {u}_{k}}{\sqrt{{u}_{k}^{2} + {v}_{k}^{2} + {f}^{2}}} , {\overline{v}}_{k} = {K}_{3} \frac{- {v}_{k}}{\sqrt{{u}_{k}^{2} + {v}_{k}^{2} + {f}^{2}}} and \\ \overline{f} = {K}_{3} \frac{- f}{\sqrt{{u}_{k}^{2} + {v}_{k}^{2} + {f}^{2}}} . & ( 29 )\end{matrix}$$

Eqs. (22), (25) and (28) form a stochastic system for vehicle information fusion and an extended Kalman filter may be used to estimate the position and velocity of the vehicle. For a CV model, minimum two scans may be needed and for a constant acceleration (CA) model minimum three scans may be needed to converge.

We claim:

1. A method of fusing video signals and Doppler radar signals for estimating moving vehicle velocity and range information, comprising the steps of:
a. matching said video signals to said Doppler radar signals; and
b. fusing the matched said video signals and said radar signals to derive said velocity and range information of said vehicle.

2. A method of fusing video signals and Doppler radar signals as recited in claim 1, wherein the method estimates Doppler angles from said video signals.

3. A method of fusing video signals and Doppler radar signals as recited in claim 1, wherein the method estimates Doppler signals from said Doppler angles.

4. A method of fusing video signals and Doppler radar signals as recited in claim 1, wherein the method matches said Doppler signals to measured Doppler signals from moving Doppler radars.

5. A method of fusing video signals and Doppler radar signals as recited in claim 1, wherein the method forms a multiple scan geometry from said video signals and said Doppler radar signals.

6. A method of fusing video signals and Doppler radar signals as recited in claim 1, wherein the method matches said video signals to measured Doppler signals from stationary Doppler radar.

7. A method of fusing video signals and Doppler radar signals as recited in claim 1, wherein the method forms a stochastic model for said video signals and said Doppler radar signals.

8. A method of fusing video signals and Doppler radar signals as recited in claim 1, wherein the method estimates said the velocity and range information from said video signals and said Doppler radar signals using said stochastic model.
